(19) United States
(12) Patent Application Publication
(10) Pub. No.: US 2020/0355240 A1
(43) Pub. Date: Nov. 12, 2020

(54) NOISE REDUCTION STRUCTURE

(71) Applicant: NOK CORPORATION, Tokyo (JP)

(72) Inventor: Yasushi TSUNA, Saihaku-gun (JP)

(21) Appl. No.: 16/962,776

(22) PCT Filed: Oct. 31, 2019
(86) PCT No.: PCT/JP2019/042821

§ 371 Date: Jul. 16, 2020

(30) Foreign Application Priority Data
Nov. 21, 2018 (JP) 2018-218180

(51) Int. Cl. F16F 15/08; F16F 1/373; F04B 53/00

(52) U.S. Cl. CPC F16F 15/08; F16F 1/3732; F16F 2234/02; F16F 2224/025; F04B 53/003

(57) ABSTRACT

Between an internal component of an operating device that generates vibrations in operation and a cover of the operating device including a radiating surface radiating a noise caused by the vibrations, a block-like vibration suppressing rubber is interposed with an interference. The position where the vibration suppressing rubber is interposed coincides with the position of an antinode in a resonance mode of the resonance frequency of the radiating surface, which resonance frequency matches the frequency of the noise to be reduced. A projection is provided at the position in the cover or the internal component where the vibration suppressing rubber is to be interposed. A mount hole is provided at the vibration suppressing rubber, and the projection is inserted into the vibration suppressing rubber through the mount hole. Thus, the vibration suppressing rubber is mounted.

### CROSS REFERENCE TO RELATED APPLICATIONS

This application is a U.S. National Phase application of International Application No. PCT/JP2019/042821, filed on Oct. 31, 2019 and published in Japanese as WO 2020/105392 A1 on May 28, 2020 and claims priority to Japanese Patent Application No. 2018-218180, filed on Nov. 21, 2018. The entire disclosures of the above applications are expressly incorporated by reference herein.

### BACKGROUND

### Technical Field

The present disclosure relates to a noise reduction structure.

### Related Art

The operating vibrations of any operating device such as an air compressor or a gearbox are transferred from an internal component (contained element) of the device to the housing of the device. From the housing, the operating vibrations are transferred to a cover that closes an opening of the housing. The operating vibrations are then radiated from the plane of the cover, to become a loud noise (radiated sound).

Conventionally, techniques disclosed in Japanese Unexamined Patent Application Publication Nos. 11-238988, 2003-176935 and others are known as structures for reducing a noise.

For example, FIG. 6A illustrates a structure in which a vibration suppressing member 101 is interposed at the interface between a housing 31 and a cover 41. FIG. 6B illustrates a structure in which a vibration suppressing paint 111 is applied or a high-damping rubber is bonded to the outer surface of the plane of the cover 41 which functions as the noise radiating surface. FIG. 6C illustrates a structure in which the cover 41 has its entire plane which functions as the noise radiating surface covered with a sound isolating member 121. FIG. 6D illustrates a structure in which a thickness t of the plane of the cover 41 which functions as the noise radiating surface is increased in order to increase the strength of the cover 41 itself.

In the structure in FIG. 6A, the vibration suppressing member 101 is, for example, a vibration suppressing element formed of a metal plate having its surface coated with a rubber film. In this case, the vibration suppressing member 101 has the gasket function in addition to the vibration suppression function. On the other hand, it may not be necessary for the vibration suppressing component interposed at the interface between the housing 31 and the cover 41 to have the gasket function. Then, the component having the redundant function incurs excessive component costs. When the vibration suppressing member 101 is a vibration suppressing element formed of a metal plate having its surface coated with a rubber film, the number of components and assembly steps is greater. Furthermore, such a structure may limit the audio range for which the noise reduction is effective to only a high frequency (KHz) range.

In the structure illustrated in FIG. 6B, when the vibration suppressing paint 111 is applied to the plane of the cover 41, the applying step incurs enormous trouble and time. Furthermore, the bonding a high-damping rubber to the plane of the cover 41 may not work when the plane of the cover 41 is uneven.

The structure illustrated in FIG. 6C necessitates a separate structure for mounting and retaining the sound isolating member 121.

In the structure illustrated in FIG. 6D, the mass of the cover 41 and consequently the mass of the operating device may extremely increase.

An object of the present disclosure is to provide a noise reduction structure capable of exhibiting an excellent noise reduction effect with a simple structure.

### SUMMARY

A noise reduction structure of the present disclosure includes a vibration suppressing rubber that is block-like and interposed, with an interference, between an internal component of an operating device that generates vibrations in operation and a cover of the operating device that includes a radiating surface radiating a noise caused by the vibrations, the vibration suppressing rubber being interposed at a position of an antinode in a resonance mode of a resonance frequency of the radiating surface matching a frequency of the noise to be reduced.

### Advantageous Effects

The noise reduction structure of the present disclosure exhibits an excellent noise reduction effect with a simple structure.

### BRIEF DESCRIPTION OF THE DRAWINGS

FIG. 1 is an explanatory illustration of one example of an operating device on which a noise reduction structure according to an embodiment is mounted.

FIG. 2A is an explanatory illustration of the noise reduction structure before applying interference load to a vibration suppressing rubber.

FIG. 2B is an explanatory illustration of the noise reduction structure after applying interference load to the vibration suppressing rubber.

FIG. 3A is a cross-sectional view and a perspective view of the vibration suppressing rubber.

FIG. 3B is a perspective view of a variation of the vibration suppressing rubber.

FIG. 4 is an explanatory illustration of antinodes in surface resonance modes of vibrations to be reduced in the noise reduction structure.

FIG. 5 is a graph for test results on the noise reduction structure.

FIGS. 6A, 6B, 6C, and 6D are each an explanatory illustration of a conventional noise reduction structure.

### DETAILED DESCRIPTION

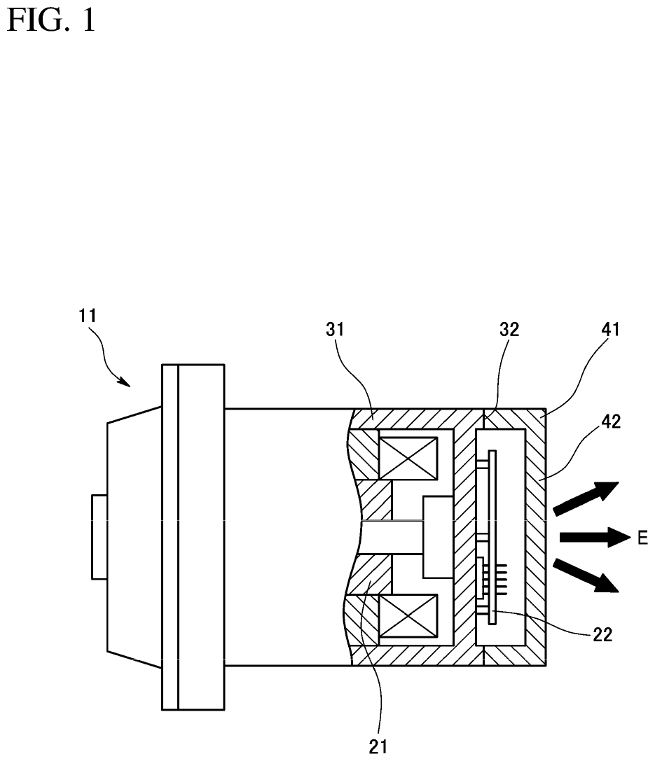

FIG. 1 illustrates the overview of an operating device 11 on which a noise reduction structure according to an embodiment is mounted. The operating device 11 is, for example, a motor-driven compressor. In the motor-driven compressor, vibrations are generated at an internal component (contained element) 21 of the device 11 by variations in compression torque or rotation, pulsation in discharging a refrigerant, eccentric rotation and the like. The generated vibrations are transferred from the internal component 21 to a housing 31 of the device 11, and then to a cover 41 that closes a housing opening 32. As indicated by arrows E, the vibrations are radiated from a planar part (noise radiating surface) 42 of the cover 41, to become a loud noise (radiated sound).

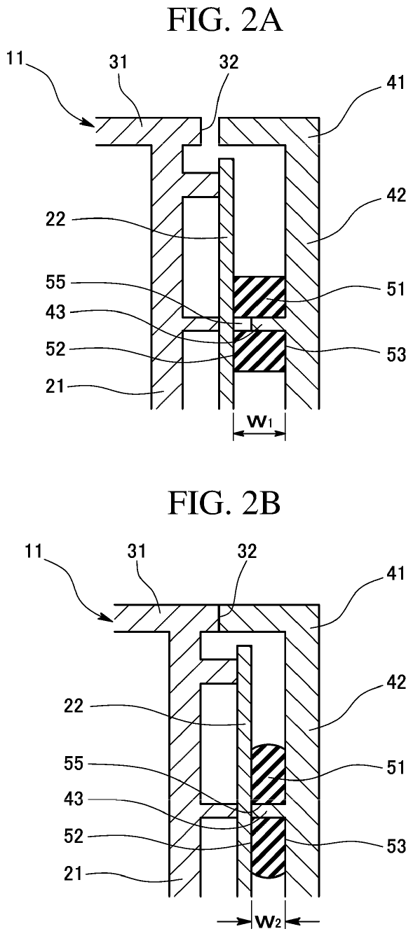

As illustrated in FIGS. 2A and 2B, the noise reduction structure includes a block-like vibration suppressing rubber 51 that is interposed between the vibration source and the noise radiating surface by a predetermined amount of interference. The vibration source is the internal component 21 of the device 11. The noise radiating surface is the planar part 42 of the cover 41. The vibration suppressing rubber 51 is mounted inside the device 11.

The internal component 21 of the device 11 may be any of various components according to the type or specification of the device. In the present embodiment, an electronic board (inverter board) 22 is disposed so as to oppose to the planar part 42. Between the electronic board 22 and the planar part 42, the vibration suppressing rubber 51 is interposed.

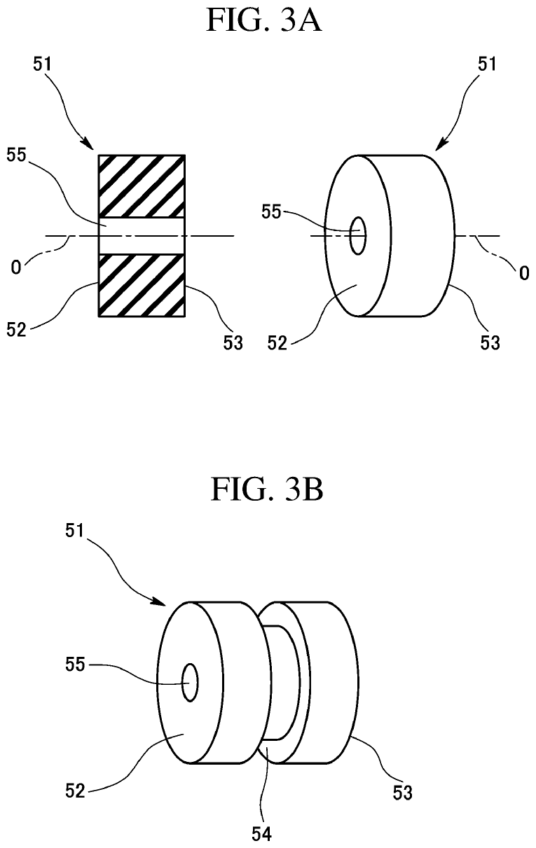

As illustrated in FIG. 3A, the vibration suppressing rubber 51 is block-like. The vibration suppressing rubber 51 is, for example, round columnar or disc-like. The vibration suppressing rubber 51 includes a first end surface 52 and a second end surface 53. As illustrated in FIGS. 2A and 2B, the first end surface 52 is in contact with the electronic board 22. The second end surface 53 is in contact with the inner surface of the planar part 42. In this state, the vibration suppressing rubber 51 is interposed between the electronic board 22 and the cover 41. As illustrated in FIG. 3B, an annular recess 54 may be provided at the outer circumferential surface of the vibration suppressing rubber 51.

As illustrated in FIGS. 2A and 2B, the vibration suppressing rubber 51 is mounted between the electronic board 22 and the planar part 42 as being compressed in the thickness direction (in the direction of the central axis 0) of the vibration suppressing rubber 51. This sets the interference (the margin of compression) for the vibration suppressing rubber 51 in the mounted state. The vibration suppressing rubber 51 before compression has a thickness w₁. The vibration suppressing rubber 51 after compression has a thickness w₂ smaller than the thickness w₁. The amount of interference is set to be greater than the vibration amplitude in the planar part 42 and taking into account of wear of rubber, so that the vibration suppressing rubber 51 keeps being constantly in contact with the planar part 42, that is, so as to prevent occurrence of any clearance between the vibration suppressing rubber 51 and the planar part 42.

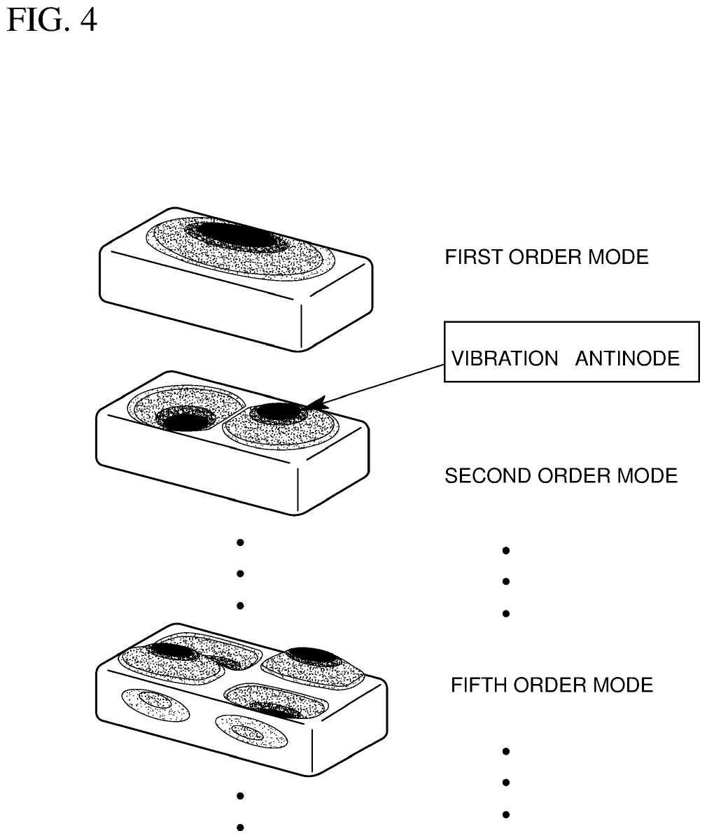

As illustrated in FIG. 4, the resonance mode at the radiating surface of the cover 41 is analyzed and measured for a plurality of orders (the first order mode, the second order mode, . . . the fifth order mode, . . . ). Then, the vibration suppressing rubber 51 is disposed at the site in the radiating surface of the cover 41 where antinodes in the resonance mode of the resonance frequency, which substantially matches the frequency of the noise to be reduced, exist (the antinode existing site).

In order for the vibration suppressing rubber 51 to be precisely mounted at the antinode existing site, a projection 43 (FIG. 2A, FIG. 2B) is provided at the inner surface of the planar part 42 so as to be positioned at the antinode existing site. The vibration suppressing rubber 51 is provided with a mount hole 55 on the central axis 0. The mount hole 55 is a through hole or a bottomed hole.

In mounting the vibration suppressing rubber 51, inserting the projection 43 through the mount hole 55 of the vibration suppressing rubber 51 for positioning allows the vibration suppressing rubber 51 to be mounted at the antinode existing site. Note that, the projection 43 may be provided on the internal component 21 side of the electronic board 22.

The cover 41 generates a loud noise when it resonates. Accordingly, by bringing the vibration suppressing rubber 51 into direct contact with the planar part 42 of the resonating cover 41 so that the vibration suppressing rubber 51 exhibits the rubber damping action on the resonance, the vibrations during resonation largely reduce.

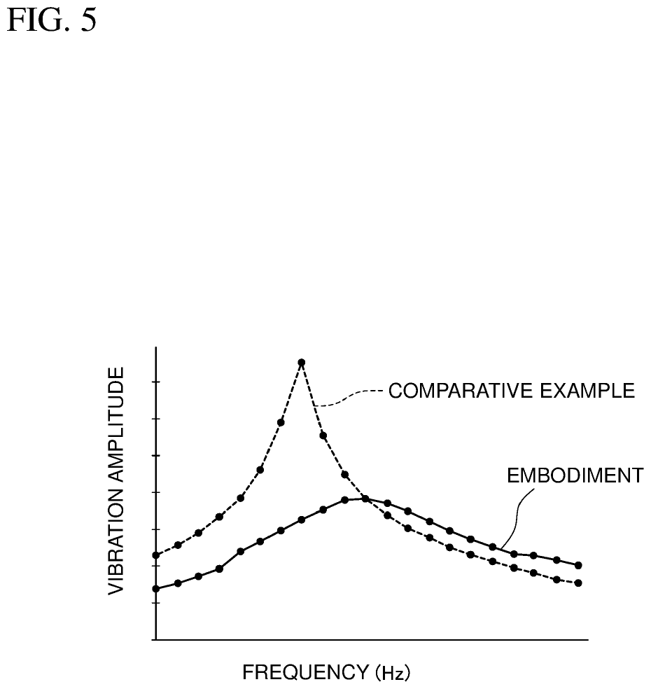

For example, as illustrated in FIG. 4, when the noise of the vibration second order mode is to be reduced, the rubber damping is applied to the position corresponding to the antinode of the vibrations of the vibration second order mode. Thus, as illustrated in the graph of FIG. 5, the vibrations during resonation largely reduce. In the graph of FIG. 5, the solid line represents the embodiment with the noise reduction structure and the broken line represents a comparative example without the noise reduction structure.

In the noise reduction structure according to the present embodiment, where and by what number the vibration suppressing rubber 51 is to be interposed are set depending on the frequency band of the noise. For example, it is assumed that the first order mode resonance frequency is 800 Hz, the second order mode resonance frequency is 1500 Hz, and the third order mode resonance frequency is 2200 Hz. Here, when the frequency of the noise to be reduced is 500 Hz to 1000 Hz, one vibration suppressing rubber 51 is interposed in the first order mode antinode. When the frequency of the noise to be reduced is 500 Hz to 1800 Hz, two or three vibration suppressing rubbers 51 are interposed in the first order mode antinode and the second order mode antinode (while there exist two second order mode antinodes, the interposing may be performed on just one of them).

In the noise reduction structure according to the present embodiment, the vibration suppressing rubber 51 is interposed between the electronic board 22, which is the internal component 21 of the operating device 11, and the planar part 42 of the cover 41 with a predetermined amount of interference. Accordingly, the rubber damping action exhibited by the vibration suppressing rubber 51 effectively reduces vibrations and noise (radiated sound) that are generated at the planar part 42.

In the noise reduction structure according to the present embodiment, the block-like vibration suppressing rubber 51 is formed, and interposed between the electronic board 22 and the cover 41 with an interference without bonding.

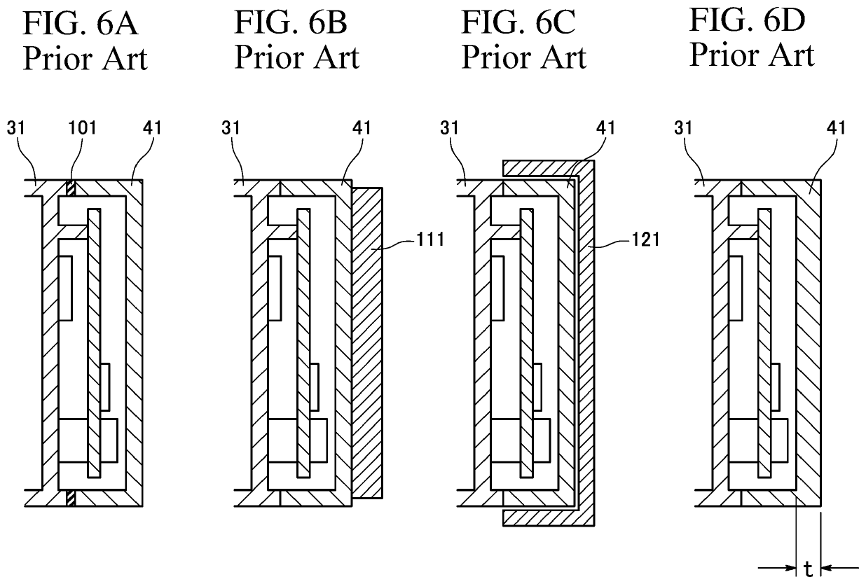

The block-like vibration suppressing rubber 51 is a component dedicated to suppressing vibration with no gasket function. This contributes to reducing the component costs. Furthermore, as compared to the vibration suppressing member 101 (FIG. 6A) which is a vibration suppressing element formed of a metal plate having its surface coated with a rubber film, the number of components and assembly steps is smaller and the audio range for which the noise reduction is effective is not limited to a high frequency region. Furthermore, the vibration suppressing rubber 51 can be mounted also when the plane of the cover 41 is uneven. Furthermore, in contrast to FIG. 6C, the present embodiment does not necessitate any separate structure for mounting and retaining the vibration suppressing rubber 51 outside the device 11. Furthermore, the mass of the cover 41 and consequently the mass of the device 11 will not extremely increase.

Thus, the noise reduction structure according to the present embodiment exhibits an excellent noise reduction effect with a simple structure.

The present embodiment provides a noise reduction structure targeted at the frequency band of the noise to be reduced. Furthermore, the present embodiment is capable of reducing a noise of a broader frequency band. Additionally, the present embodiment provides a noise reduction structure formed of a rubber product of the minimum required dimension and costs for the target noise frequency band.

### INDUSTRIAL APPLICABILITY

The noise reduction structure according to the present embodiment is suitably used in the field of a refrigerant compressor for a vehicle air conditioner, a refrigerant compressor for a heat pump, an electric control unit, an electronic control unit, a gearbox or the like.

1.-2. (canceled)

3. A noise reduction structure comprising:
an operating device that includes an internal component generating vibrations in operation;
a cover of the operating device that has a radiating surface radiating a noise caused by the vibrations; and
a vibration suppressing rubber that is block-like and interposed between the internal component and the cover, wherein
the vibration suppressing rubber is disposed at a position of an antinode in a resonance mode of a resonance frequency of the radiating surface.

4. The noise reduction structure according to claim 3, wherein the internal component is disposed so as to oppose to the radiating surface.

5. The noise reduction structure according to claim 3, wherein the vibration suppressing rubber is circular columnar or disc-like.

6. The noise reduction structure according to claim 5, wherein the vibration suppressing rubber includes an annular recess at its outer circumferential surface.

7. The noise reduction structure according to claim 3, wherein
the vibration suppressing rubber includes a mount hole, and
the cover includes a projection configured to be inserted into the mount hole at an inner surface of the radiating surface.

8. The noise reduction structure according to claim 3, wherein
the vibration suppressing rubber includes a mount hole, and
the internal component includes a projection configured to be inserted into the mount hole.

9. The noise reduction structure according to claim 4, wherein the vibration suppressing rubber is circular columnar or disc-like.

10. The noise reduction structure according to claim 9, wherein the vibration suppressing rubber includes an annular recess at its outer circumferential surface.

11. The noise reduction structure according to claim 4, wherein
the vibration suppressing rubber includes a mount hole, and
the cover includes a projection configured to be inserted into the mount hole at an inner surface of the radiating surface.

12. The noise reduction structure according to claim 5, wherein
the vibration suppressing rubber includes a mount hole, and
the cover includes a projection configured to be inserted into the mount hole at an inner surface of the radiating surface.

13. The noise reduction structure according to claim 6, wherein
the vibration suppressing rubber includes a mount hole, and
the cover includes a projection configured to be inserted into the mount hole at an inner surface of the radiating surface.

14. The noise reduction structure according to claim 4, wherein
the vibration suppressing rubber includes a mount hole, and
the internal component includes a projection configured to be inserted into the mount hole.

15. The noise reduction structure according to claim 5, wherein
the vibration suppressing rubber includes a mount hole, and
the internal component includes a projection configured to be inserted into the mount hole.

16. The noise reduction structure according to claim 6, wherein
the vibration suppressing rubber includes a mount hole, and
the internal component includes a projection configured to be inserted into the mount hole.
